(19) United States
(12) Patent Application Publication
(10) Pub. No.: US 2013/0298374 A1
(43) Pub. Date: Nov. 14, 2013

(54) TIE ROD END REMOVAL TOOL

(71) Applicant: Robert Bruce Lucas, Mesa, AZ (US)

(72) Inventor: Robert Bruce Lucas, Mesa, AZ (US)

(21) Appl. No.: 13/469,127

(22) Filed: May 11, 2012

(51) Int. Cl. B25B 27/00; B25B 27/02

(52) U.S. Cl. CPC B25B 27/0035; B25B 27/02
USPC 29/426.5; 29/283

(57) ABSTRACT

A tie rod removal tool including a monolithic body having a hardness greater than number 5 steel, the body having an internal opening, the opening extending to at least one end of the body, the opening further including at least two (2) threaded sections, each said threaded section having a different diameter.

### FIELD OF THE DISCLOSURE

The disclosed embodiments relate generally to the field of tools to remove the tie rod end of a vehicle, more particularly for the removal of the tie rod end for a truck such as a semi-truck, at times such a truck may also be referred to as an eighteen (18 wheeler). The disclosed tool may also have applications for automobiles, off-road vehicles (“ATVs”), and off-road machinery, such as farm equipment and/or constructions equipment, or any other machinery that includes tie rods.

### BACKGROUND

An embodiment of a tie rod end is described in U.S. Pat. No. 4,059,361 and is illustrated in FIGS. 1-5. Referring now to the drawings, wherein an embodiment of a tie rod end is illustrated, FIG. 1 shows the construction of a tie rod end assembly 10. The tie rod end 10 has a housing 12 with a socket portion 14 and a stem portion 16. Positioned within the socket 14 are a plastically deformable lead washer 18 and a hard steel washer 20.

A generally annular bearing 22 is positioned against the washer 20. A ball stud 24 has a ball 26 at its lower end positioned against the bearing 22. The shank 28 of the stud 24 extends from the socket 14. A second generally annular bearing 30 is positioned about the shank 28 and against the ball 26. The bearings 22 and 30 are of identical construction. Referring to FIGS. 4 and 5, the configuration of the bearing 30 is shown prior to its installation into the socket 14. Bearing 30 is generally annular with a cylindrical outer surface 32 and a partially spherical inner bearing surface 34. The bearing 30 has a full slot 36 that extends completely through the bearing material. Three circumferentially spaced apart slots 38, 40 and 42 extend part way through the bearing 30 and divide it (in combination with the slot 36) into four bearing segments. Because the slots 38, 40 and 42 extend only part way through the bearing 30, tie bars 39, 41 and 43 remain which hold the four segments together. The tie bars 39, 41 and 43 holding the bearing segments together are easily fractured under load.

A closure member 44 having a socket closure portion 46 and a stem closure portion 48 is positioned over the housing 12. The socket closure portion 46 is in engagement with the upper bearing 30. The socket closure 46 has an opening 47 through which the shank 28 of the ball stud 24 extends. The stem closure portion 48 engages the stem portion 12 of the housing 10 whereby a hollow stem for attachment to a steering linkage element is formed. The inner end of the hollow stem is sealed by a rubber plug 50. The socket closure portion 46 of the closure member 44 has a central opening to accommodate the shank 28 of the ball stud 24. The socket closure portion 46 has an internal configuration to complement the socket 14 in order to retain the bearings 22, 30 and ball stud 24. The periphery of the closure member 44 is provided with an outwardly extending flange 52 which overlays a peripheral flange 54 formed on the housing part 12. The closure member 44 and housing 12 are secured together by crimping over the edge 56 of the housing flange 54.

The tie rod end assembly 10 includes a boot type dust seal 58 which has a first portion is sealed engagement with the closure member 44 and a second portion that is in sealed engagement with the shank 28 of the ball stud 24. The boot seal 58 prevents the entry of contaminants into the interior of the assembly where they might abrade the bearing surfaces.

The tie rod end assembly 10 is manufactured by first placing the lead washer 18 and steel washer 20 at the base of the socket portion 14. The rubber plug 50 is positioned at the inner end of the stem portion 16 of the housing part 12. The bearing 22 is placed on the steel washer 20 and lubricant is injected into the interior of the socket portion 14. The ball end 26 of the stud 24 is placed in engagement with the bearing 22 and the second bearing 30 is slipped over the shank 28 and into engagement with the ball end 26. The closure member 44 is located on the housing 12 and the flanged edge 56 of the housing 12 is crimped over to lock the closure member 44 in engagement with the housing 12. The securing of the closure member 44 to the housing part 12 will exert a load on the bearings 22 and 30 which will cause the tie bars connecting the bearing segments to fracture whereby the bearings 22 and 30 will each become circumferentially spaced apart bearing pieces.

The interior of the stem portion 16 and closure portion 48 is internally threaded as indicated by reference numeral 60 to accommodate attachment to a steering linkage element. It is also noted that the shank 28 of the stud 24 is constructed to be connected to another element of a steering linkage system. The assembly or manufacture of the tie rod end 10 is completed by placing the boot seal 58 in position.

Previously used tools to remove the tie rod end include a pickle fork or a puller. Typical issues with the use of a pickle fork include but are not limited to tearing the boot of the ball joint, stretching the socket of the ball joint, or issues with injury to the user.

### BRIEF DESCRIPTION

One embodiment disclosed herein is a tie rod removal tool. The tool comprises a monolithic body having a hardness greater than number 5 steel. The body further includes an internal opening, the opening extending to at least one end of the body, the opening further comprising at least two (2) threaded sections, each said threaded section having a different diameter.

Another embodiment disclosed herein includes a tie rod removal tool having a monolithic body with a hardness greater than number 5 steel. The body having at least four (4) external surfaces, the tool having at least three (3) internal openings, each opening extending from a different surface than either of the other openings toward an interior of the tool, each internal opening including a threaded section, and each opening sized to engage a different sized object than either of the other two openings.

### BRIEF DESCRIPTION OF THE DRAWINGS

FIG. 1 is a side view in section of a new tie rod end construction;

FIG. 2 is a top plan view of a tie rod end of FIG. 1 with the rubber boot seal removed;

FIG. 3 is an elevational view of the stem end of the tie rod end;

FIG. 4 is a sectional view of one of the bearing means of the tie rod end;

FIG. 5 is a bottom plan view of the bearing of FIG. 4 taken in the direction of arrows 5-5;

FIG. 6 is a side (plan) view of a tool for removing a tie rod end described herein;

FIG. 7 is a cut away view of the tool shown in FIG. 6 taken in the directions of arrows 7-7;

FIG. 8 is a front view of another embodiment of a tool for removing a tie rod end described herein;

FIG. 9 is an internal schematic view of the tool illustrated in FIG. 8;

FIG. 10 is a perspective view of another tool described herein; and

FIG. 11 is a top view of the embodiment of the tool shown in FIG. 10.

### DETAILED DESCRIPTION

Tool 100 is shown in FIG. 6. As shown tool 100 has a monolithic body 102.

Body 102 may also be referred to as a unitary piece. Preferably body 102 is constructed from a hard material. An example of a preferred hardness is that body 102 has a hardness greater than that of number 5-carbon steel as per the SAE standard for steel hardness. Particular preferred examples hardness of body 102 include the hardness of number 8-carbon steel or number 10 carbon steel. Body 102 may be constructed from any suitable type of metal, ceramic, plastic, or composite material with the above specified hardness.

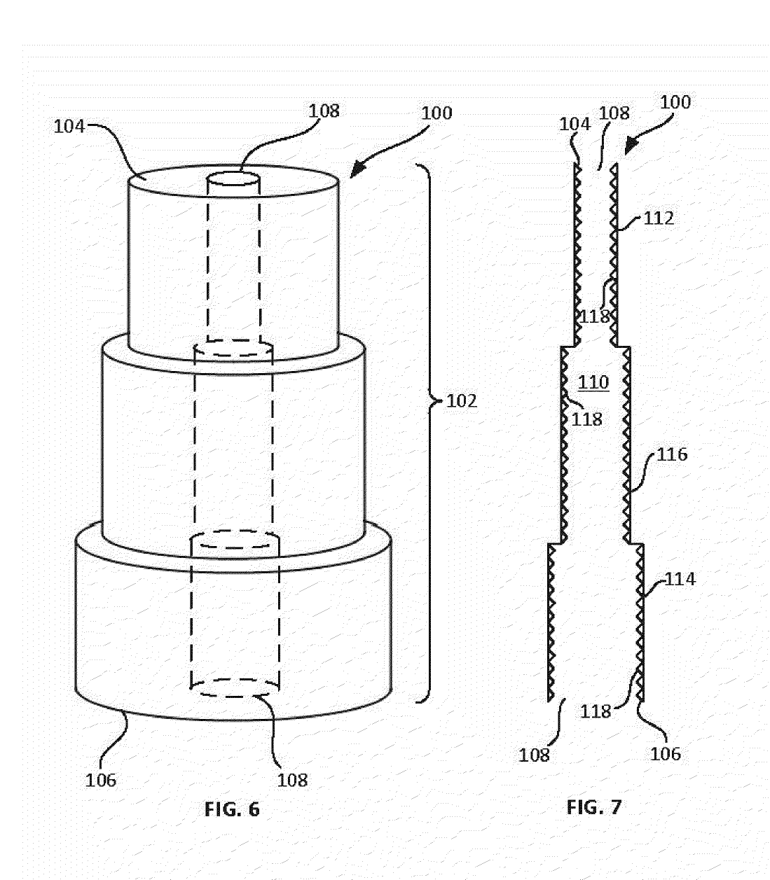

As shown, tool 100 has opposed ends 104 and 106. It is preferred that at least one of the ends, alternatively both of the ends, have an opening 108. Tool 100 further includes an internal passage 110, as shown in FIG. 7, in communication with opening 108 at least one of the ends 104 or 106 of tool 100. In the case that tool 100 has an opening 108 at both ends 104 and 106 passage 110 is in communication with each of openings 108. In an alternate embodiment, passage 110 does do not extend from one end of tool 100 to the other. In this embodiment, central portion of passage 110 is solid so that a user may use each of the threaded sections, but an object could not pass all the way through the interior of tool 100.

The exterior of body 102 may have any kind of desired shape, such as but not limited to cylindrical or rectangular. Other examples of the exterior shape of body 102 include a square exterior or a hexagonal shaped exterior. The exterior surface of body 102 may be smooth or shaped to suitable to engage with a socket, box wrench, crescent wrench, or other tool of choice. Lastly, the exterior of body 102 may be tiered or tapered from one end 104 to the other end 106 or vice versa in any preferred configuration.

As depicted in FIG. 7, passage 110 includes at least two (2) segments 112 and 114, preferably more than two (2) segments, such as but not limited to three (3) segments 112, 114 and 116. Each segment has a different diameter than another segment. Furthermore, each segment 112, 114, and 116 is threaded. In one particular embodiment the threads 118 in each segment 112, 114 and 116 are fine threads. However threads 118 may be fine threads, course threads or any combination thereof. Additionally, threads 118 may be sized for English or metric measuring systems.

Exemplary embodiments of passage 110 may be sized to engage either metric or English sized objects. In one embodiment, passage 110 includes at least three segments. The first segment is sized to engage as ½″ sized object, the second segment is sized to engage a ⅝″ sized object and the third segment is sized to engage a ¾″ sized object. In another embodiment, the segments are respectively sized to engage objects sized such as ⅝″, ¾″ and ⅞″. The disclosed embodiment of tool 100 may be designed to engage any desired sized objects and in not limited to only the above disclosed embodiments. Alternatively, it may be sized to fit both English and metric sized objects.

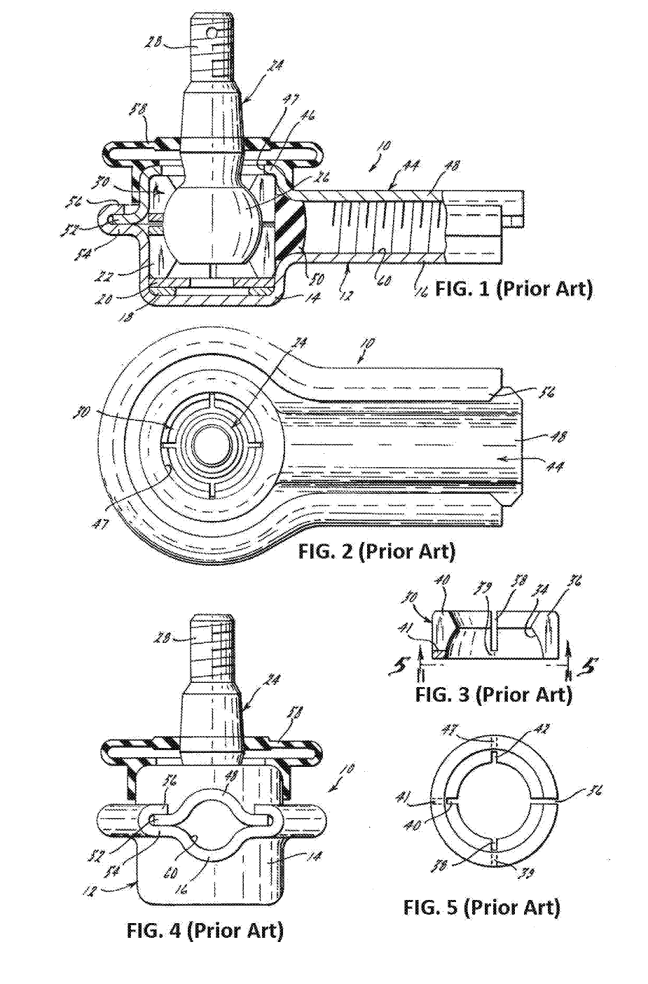

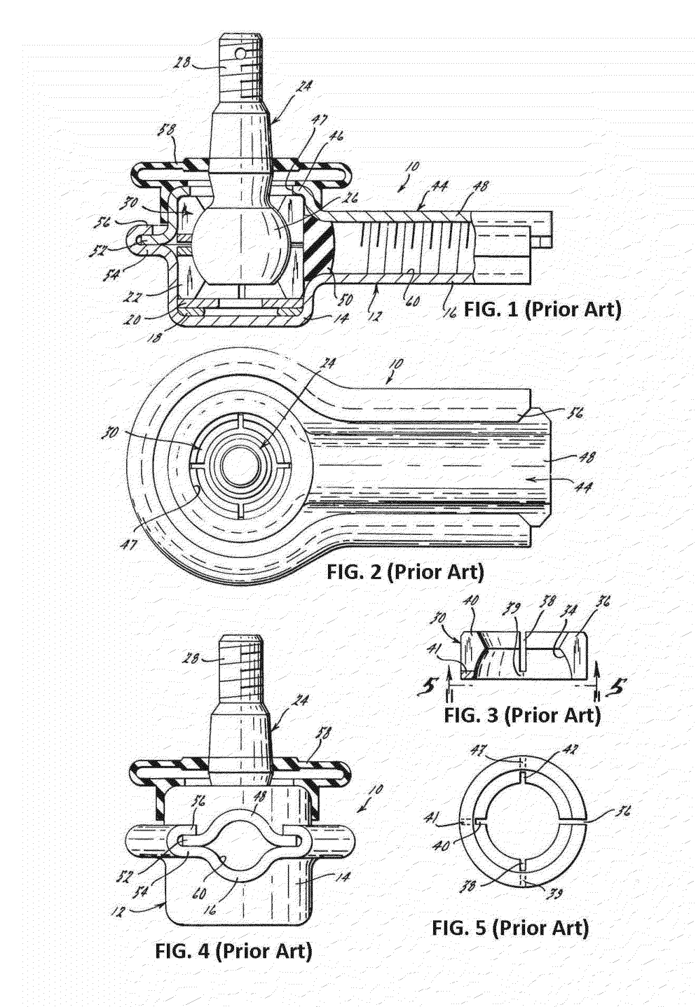

Tool 100 may be used in the following manner. First if present, a cotter pin or other type of retaining clip is removed from hole 29 in stem 28 as shown in FIG. 1. In addition to or in place of the cotter pin, a retaining nut may be present. The retaining nut should be removed also, if present. Tool 100 has at least one segment sized to engage the threads on stem (shank) 28. Tool 100 is aligned with stem 28 such that the segment of tool 100 designed to engage stem 28 is in engagement with stem 28. In the case of stem 28 being threaded, tool 100 is threaded onto stem 28. In this orientation one end of tool 100 is adjacent the tie rod end and a second end of tool 100 is open. The user strikes the open end of tool 100 with a hammer or other object until tie rod end 10 is no longer in communication with the suspension and/or steering system for the vehicle and/or the wheel of the vehicle. The freeing of the tie rod end from being in communication with both the wheel of the vehicle and the suspension and/or steering system for the vehicle may be accomplished without the use of either or both of a pickle fork or a puller.

An alternative embodiment for using tool 100 could be to use a clamping element. Preferably, the stationary end of the clamping element would be attached to a robust part of the vehicle that is located above the portion of the tie rod that is engaged by tool 100. Preferably the robust part of the vehicle is a stationary part. The desired threaded section of tool 100 is engaged to an end of the tie rod. The portion of the clamping element that is movable is aligned with the end of tool 100 that is not engaging the tie rod. The movable portion of the clamping element engages the end of tool 100 not adjacent the tie rod end. The user tightens the clamping element until the tie rod end is unattached from the wheel of the vehicle. In a certain embodiment of tool 100 for this use, preferably, the surface of tool 100 that is engaged with the clamping element reasonably mates with the movable portion of the clamping element such that upon the application of the clamping force, the clamping element and tool 100 do not become disengaged. For example, such surface of tool 100 may designed to mate with the movable platen of a C-clamp.

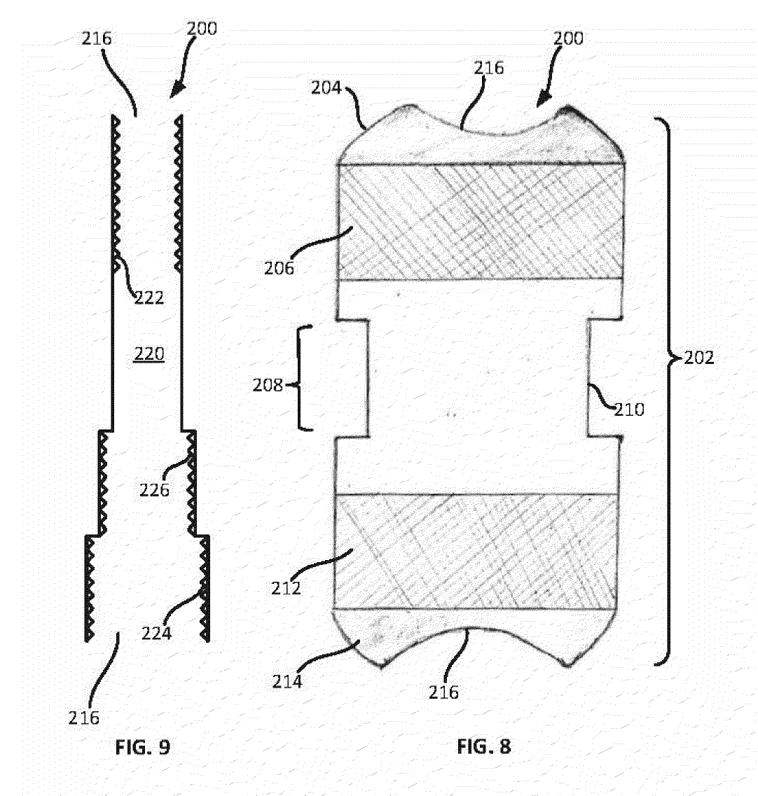

Tool 200 is illustrated in FIG. 8. Tool 200 also includes a monolithic body 202. In one certain embodiment the overall length of body 200 is about three (3) inches. Body 202 is not limited to the stated length. Tool 200 may be made to any desired overall length. As shown, body 202 has a generally cylindrical shape. Body 202 is not limited to any particular general shape. It is further depicted that body 202 has a first portion tapered portion 204. In the embodiment shown tapered portion 204 is tapered toward the end of body 202. Tapered portion 204 may have any desired amount of taper. A factor to be considered is the desired size of the face (not shown) of tool 200 at such end.

Depicted body 202 further includes a textured portion 206. Any desired texture may be used. A benefit of textured portion 206 is it is easier for a user to grasp and retain tool 200 with their hand or other retaining element. The length of portion 206 may be any desired length.

Body 202 additionally includes a central grooved portion 208. In a particular embodiment grooved portion 208 is designed to fit a crescent wrench. Grooved portion may be designed to fit any desired wrench size, e.g. metric size or English size. In one embodiment, grooved portion 208 is designed to fit a one (1″) inch crescent wrench. In a further particular embodiment, grooved portion has total length of one-half (1.5″) inches and the length of the groove 210 is one (1″) inch.

An alternate embodiment of grooved portion 208 would be for the groove to be shaped in a hexagonal shape similar to a standard sided shape for a nut that engages a bolt.

Body 202 also includes a second textured portion 212. Like portion 206, any desired texture may be used. A benefit of textured portion 212 is it is easier for a user to grasp and retain tool 200 with their hand or other retaining element. The length of portion 212 may be any desired length. Textured portion 212 may have the same properties of textured portion 206 or different properties. For example each textured portion 206, 212 may have the same type of texturing and/or the same length.

Furthermore as shown in FIG. 8, body 202 includes a second tapered portion 214. In the embodiment shown tapered portion 214 is tapered toward the adjacent end of body 202. Tapered portion 214 may have any desired amount of taper. A factor to be considered is the desired size of the face (not shown) of tool 200 at such end.

As discussed, at each end of body 202, tool 200 includes a face. Each face may be flat or have a recess or any other desired shaped surface. As outlined in FIG. 8, the embodiment shown had a recess on each face. In one embodiment, the face is sized receive a hammer of any desired size. In particular embodiments, the face on one end of the body 202 is different in size than the face on the opposing side of body 202. As depicted the face on the top end of body 202 adjacent tapered portion 204 is smaller than the face adjacent tapered portion 214. Not shown in FIG. 8 each face has an opening 216 as shown in FIG. 9. With respect to a further desired shape for the end face an example of such as shape may include a dome like shape.

Illustrated in FIG. 9 is an internal view of tool 200, tool 200 includes an internal opening 220. As shown opening 220 extends from one end of tool 200 to the other end of tool 200. In an embodiment, opening 220 was disposed in a center of body 202. Embodiments contemplated herein of tool 200 are not limited to opening 220 extending completely through all of tool 200. For example in an alternative embodiment of opening 220 may include a first portion extending from one face of tool 200 into an internal segment of body 202. The opening may further included a second portion extending from a second face of tool 200 into a second internal segment of body 202. This embodiment differs from the opening 220 previously described in that the first portion and the second portion are not connected. In a particular embodiment, the central internal portion of body 202 is solid.

As shown in FIG. 9, at first end (the top) of tool 200, opening 220 has a first threaded segment 222. Threaded segment 222 may have fine threads or any other desired type threads; fine threads, coarse threads, etc. The size of threaded segment 222 may be any desired size, English or metric. In a particular embodiment the threaded segment 222 is sized to fit a ⅝″ object. Threaded segment 222 may have any desired length.

Tool 200 may further include a second threaded segement 224 at a second end (the bottom) of tool 200. Second threaded segment 224 may have fine threads or any other desired thread types, fine threads, coarse threads, etc. The size of threaded segment 224 may be any desired size, English or metric. In a particular embodiment the threaded segment 224 is sized to fit a ⅞″ object. Threaded segment 224 may have any desired length.

Tool 200 may further include a third threaded segment section 226. Third threaded segment 226 may have fine threads or any other desired thread types, fine threads, coarse threads, etc. The size of threaded segment 226 may be any desired size, English or metric. In a particular embodiment the threaded segment 226 is sized to fit a ¾″ object. Threaded segment 226 may have any desired length.

In another embodiment it is preferred that third segment 226 is adjacent either one of the first segment 222 or the second segment 224. It is preferred that in such embodiment, third segment 226 has an internal opening which is smaller than the threaded segment it is adjacent. For example, if segment 226 is adjacent a segment having an opening sized to fit a ⅝″ object, segment 226 would be sized to fit a ½″ sized object.

Though not shown, if desired tool 200 may include one or more internal threaded segments in addition to the first three (3) threaded segments 222, 224, and 226 described above. Typically in the case of abutting threaded segments, the more outer segment is larger than the more inner located thread segment. In other terms, the threaded segment closer to an end of tool 200 is typically larger than abutting segment farther away from such end.

The threaded segments described herein may have any desired length. The particular threaded segments may have the same length, different lengths, or any combination thereof.

Tool 200 may be used in the same manner as tool 100 described above.

Either one of tool 100 or tool 200 may include a fourth threaded section. Preferably the fourth threaded section would be on the side of the Tool 100 or 200 that does not have the third treaded section. Another way to state this is that the fourth threaded section would be disposed opposed to the third threaded section. A second alternative to describe the location of the fourth threaded section is that the fourth threaded section is located on the side of the tool, which previously only had one threaded section.

For particular embodiments of a tool which have adjacent threaded sections, it is preferred that the threaded section sized to fit a larger object, in the lengthwise direction of the tool, is closer to the end of the tool whereas the threaded section sized to fit the smaller object is closer to the center of the tool in lengthwise direction of the tool. Alternatively, the lengthwise direction of the tool may be referred to as the axial direction of the tool.

The various threaded sections may have any desired threads per inch (“TPI”). Typically, the TPI may be any desired number of threads per inch; examples include 10 TPI, 12 TPI, 14 TPI, 16 TPI, 18 TPI, and 20 TPI.

Another optional feature may be that one or more slots are included in the threads of one or more of the threaded sections. A function of the slot is that it can be used to clean and/or repair the threads on the tie rod end. With the slot(s), the threaded section having one or more slots may function similar to a thread-dressing nut. Another way to describe a function of slots to assist in cleaning the threads of the tie rod end is that the slots assists in cleaning the threads of the tie rod end in a similar manner as to the gaps between the cutting heads of a die.

In another embodiment of the tools described herein, the afore mentioned slot or slots in the threaded section or sections function to straighten damaged threads on the tie rod end. This can result in restore the threads on the tie rod end into a more workable embodiment than prior to disengaging the tie rod end.

In addition to the above embodiments, it is contemplated that metric and English sized threaded sections may be included in the same tool. For example for a tool having three threaded sections one or two of the threaded sections may be sized to fit a metric object and the other threaded sections sized to fit an English sized object. Similarly in a four threaded section tool, one or two of the threaded sections may be sized to fit a metric sized object and two or three of the threaded section may be sized to fit an English sized object or vice versa. An illustrative embodiment of this in terms of FIG. 9, is if the tool shown included a fourth threaded section adjacent to threaded section 222. Such metric section can be sized to fit any desired size.

An advantage of using the tool described herein to remove a tie rod end of a vehicle is that the tool does not engage the ball of the tie rod end; as such the ball will not be damaged. Such damage is not uncommon when using a pickle fork to remove the tie rod end.

Above, described is a 3-N-1 tool (Tool 100) and a 4-N-1 (tool 200), the tool contemplated herein may have any desired number of threaded sections, preferably at least two (2). Other embodiments of the tool include a 5-N-1 tool and a 6-N-1 tool. In each of these embodiments, at least one of the sides of the tool will include at least three (3) differently sized threaded sections, in one embodiment, both sides of the tool. Such tools may mix and match threaded sections to fit either English or metric sized objects.

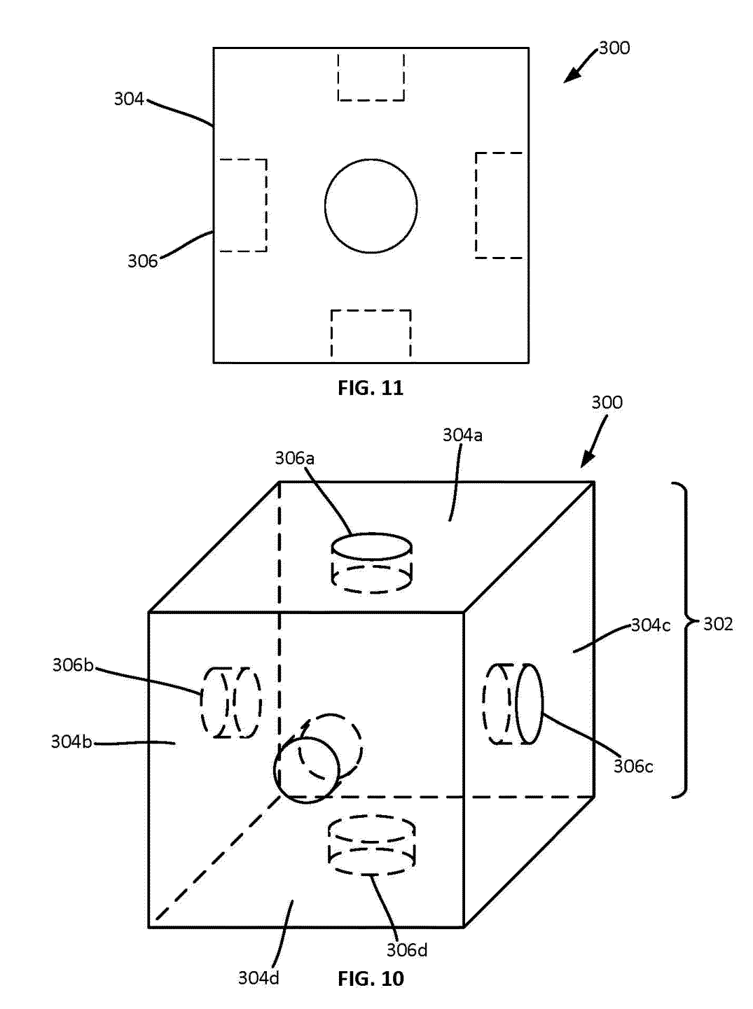

An embodiment of the 6-N-1 tool is shown in FIG. 10 as tool 300. As shown tool 300 has an exterior body 302 in the shape of a cube. In one certain embodiment, body 302 is a two (2″) inches by two (2″) inches by two (2″) inches cube. Tool 300 is not limited to having a cube shaped body.

As shown each face 304 of cube 300 includes a threaded internal opening 306. The opposing internal openings may be aligned or unaligned as desired or any combination thereof. By way of example opening 306a on face 304a may be aligned or unaligned with opening 306b on face 304b, the same is true for openings 306c and 306d. The openings 306 in tool 300 may be any desired sizes and have any desired threaded portions. Additionally the threaded portions of openings 306 may include one or more slots so that the threads have the aforementioned dressing capability.

FIG. 11 is a top view of an alternate embodiment of tool 300 that includes rounded edged as compared to the embodiment of tool 300 shown in FIG. 10.

Cube body 302 may be used for a 6-N-1 tool or any other desired numbers of openings that is desirable for such a tool.

Also, the exterior body of the tools described herein is not a limiting factor. The exterior body of the tool may have any given shape.

Any example of a depth of a threaded portion described herein is about ½ (0.5″) inches. However, if a different thread depth is desired, such thread depth is applicable to the tools contemplated herein.

The openings in the tool described herein along with the threaded portions of the opening are applicable to any type of measuring system now know and/or subsequently developed. Such systems may be utilized in any desired combination. A non-limiting example of such systems includes the metric system, the English system, the British Imperial system, the international system of units, ISO metric system, unified national standards system.

A concept that is applicable to all of the embodiments is that each threaded section of any one of tools 100, 200, or 300 may be designed for a particular embodiment. For example one such embodiment may include that each threaded section is designed for a semi-truck, such as one for a Volvo semi, Freightliner semi, a Mac semi, Peterbilt semi, Kenworth semi, or a Benz semi. Any combination of the above may be combined. Another concept may be the threaded sections of tool 100, 200, or 300 may be designed for cross vehicle type lines, such that one threaded section is designed for an automobile, another threaded section for a semi-truck and further threaded sections in the tool may be designed for the stem of a tie-rod end for any one of the following of farm equipment, construction equipment, or ATV. These concepts can be practiced in any combination thereof.

Another embodiment disclosed herein is a tool for removing a tie rod end. The tool includes a monolithic body and a plurality of threaded sections, each threaded section is designed to engage the stem of a tie rod end of a given size. Each threaded section is designed to engage a different sized stem that any other threaded section of the tool. Preferably, each threaded section extends inward into the interior of the monolithic body. Further preferred, at least two of the threaded sections extend from an outer surface of the monolithic body to the interior of the tool.

The above embodiments of the various elements of the tool described herein are not limited to any particular size recited. The tool described herein can be practiced at any desired sizes. Also the various alternative embodiments discussed herein may be practiced in any desired combination. Such alternatives are not limited to only as described above.

What is claimed is:

1. A tie rod removal tool comprising a monolithic body having a hardness greater than number 5 steel, the body having an internal opening, the opening extending to at least one end of the body, the opening further comprising at least two (2) threaded sections, each said threaded section having a different diameter.

2. The tool of claim 1 further comprising a third threaded section having a different diameter than the first two threaded sections.

3. The tool of claim 2 wherein each of the diameters sized to fit English sized object.

4. The tool of claim 4 wherein the first internal diameter of the three diameters sized to fit a five-eighths an inch (⅝″) object and the second and third diameters sized to fit objects large than five-eighths inch (⅝″).

5. The tool of claim 2 wherein each of the diameters sized to fit metric sized object.

6. The tool of claim 2 wherein the body hardness at least equal to number 8 steel.

7. The tool of claim 2 wherein the internal opening extending to a second end of the body.

8. The tool of claim 2 wherein each threaded section includes fine threads.

9. The tool of claim 2 wherein the internal diameter of first threaded section sized to fit a ⅝″ object, the internal diameter of the second threaded section sized to fit a ¾″ object, and the internal diameter of the third threaded section sized to fit a ⅞″ object.

10. The tool of claim 2 further comprising a fourth threaded section having a different diameter than all of the first two threaded sections and the third threaded section, the fourth threaded section disposed opposed to the third threaded section.

11. The tool of claim 10 wherein the diameter of the fourth threaded section sized to fit a metric object and the first two threaded sections sized to an English sized object.

12. The tool of claim 10 wherein further comprising at least one slot in the threads of at least one of the first two threaded sections, the third threaded section and the fourth threaded section.

13. The tool of claim 2 wherein at least one of the first two threaded sections and the third threaded section sized to fit a English sized object and at different one of the first two threaded sections and the third threaded section sized to a metric object.

14. The tool of claim 2 wherein further comprising at least one slot in the threads of at least one of the first two threaded sections and the third threaded section.

15. A method of removing a tie rod end of a vehicle comprising using the tool of claim 1 without using a pickle fork or a puller.

16. A tie rod removal tool comprising a monolithic body having a hardness greater than number 5 steel, the body having at least four (4) external surfaces, the tool having at least three (3) internal openings, each opening extending from a different surface than either of the other openings toward an interior of the tool, each internal opening including a threaded section, and each opening sized to engage a different sized object than either of the other two openings.

17. The tie rod of claim 16 further comprising at least three (3) additional more internal openings, each one of the additional openings disposed on a different surface either one of the two additional openings and each of the three internal openings.

18. The tie rod of claim 17 wherein each internal opening sized to engage an English sized object and each additional opening sized to engage a metric sized opening.

19. The tie rod of claim 16 wherein at least one of the internal openings sized to engage an English sized object and another one of the internal openings sized to engage a metric sized object.

20. A tool having a monolithic body and plurality of threaded openings, each opening designed to engage the threaded stem of a tie rod end of a vehicle, each opening sized to engage a different sized stem of a tie rod end than any one of the other openings, at least of two of the openings extending from an outer surface of the body toward the interior of the body.
